(19) United States
(12) Patent Application Publication
(10) Pub. No.: US 2004/0128545 A1
(43) Pub. Date: Jul. 1, 2004

(54) Host controlled dynamic firewall system

(75) Inventor: Vijaylaxmi Chakravarty, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY

(21) Appl. No.: 10/334,475

(22) Filed: Dec. 31, 2002

(51) Int. Cl. G06F 11/30

(52) U.S. Cl. 713/201

(57) ABSTRACT

A method, system, apparatus, and computer program product are presented for dynamically controlling a set of filtering-related operations at a firewall from one or more hosts. Instead of having a firewall monitor all of the command channels of different hosts within the protected domain, each host monitors its own command channels, and each host instructs the firewall as to which ports to open when communication protocol commands are detected. A host sends a command to the firewall to request the establishment of a filter rule at the firewall; these firewall operations may be secured through encryption, authentication, and authorization operations. Thereafter, the firewall allows data transfers that correspond to the detected protocol commands. The resulting firewall is much more lightweight and much faster than typical firewall implementations because the firewall neither has to monitor command channels nor parse differently formatted commands from different applications.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for the operation of a firewall.

2. Description of Related Art

Many different communication protocols may be used to implement a communication channel between two computers, e.g., a client and a server. When certain communication protocols are used to initiate a data transfer, even though the protocol commands are sent on well-defined ports, data is sent on a random port that is dynamically determined during the creation of the communication channel.

Firewalls are often employed to protect resources within a given computational domain. To accommodate the dynamic nature of communication channels, many communication protocols require the dynamic creation of filtering rules at a firewall. Currently, dynamic firewall implementations create filtering rules that facilitate data transfers by monitoring the protocol commands that are sent and received. In these firewall implementations, the firewall must monitor the transmitted commands and then parse each command in order to learn the communication channel information within each command. These parsing operations reduce the speed of a firewall. Moreover, different applications can send the communication channel information in different formats, each of which needs to be handled differently by the firewall. Communication channels cannot be established if the firewall cannot parse the request commands, thereby causing operations within applications to fail.

Therefore, it would be advantageous to provide the ability to enable dynamic filtering operations within a firewall while reducing the computational burden on the firewall.

### SUMMARY OF THE INVENTION

A method, system, apparatus, and computer program product are presented for dynamically controlling a set of filtering-related operations at a firewall from one or more hosts. Instead of having a firewall monitor all of the command channels of different hosts within the protected domain, each host monitors its own command channels, and each host instructs the firewall as to which ports to open when communication protocol commands are detected. A host sends a command to the firewall to request the establishment of a filter rule at the firewall; these firewall operations may be secured through encryption, authentication, and authorization operations. Thereafter, the firewall allows data transfers that correspond to the detected protocol commands. The resulting firewall is much more lightweight and much faster than typical firewall implementations because the firewall neither has to monitor command channels nor parse differently formatted commands from different applications.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a distributed data processing system with a typical firewall implementation;

FIG. 3 depicts a flowchart that shows a process in which the parsing of protocol commands is performed by a host system in accordance with the present invention;

FIG. 4 depicts a distributed data processing system that includes a firewall system implemented in accordance with the present invention; and

FIG. 5 depicts a block diagram that shows a host controlled dynamic firewall system for an example using FTP.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

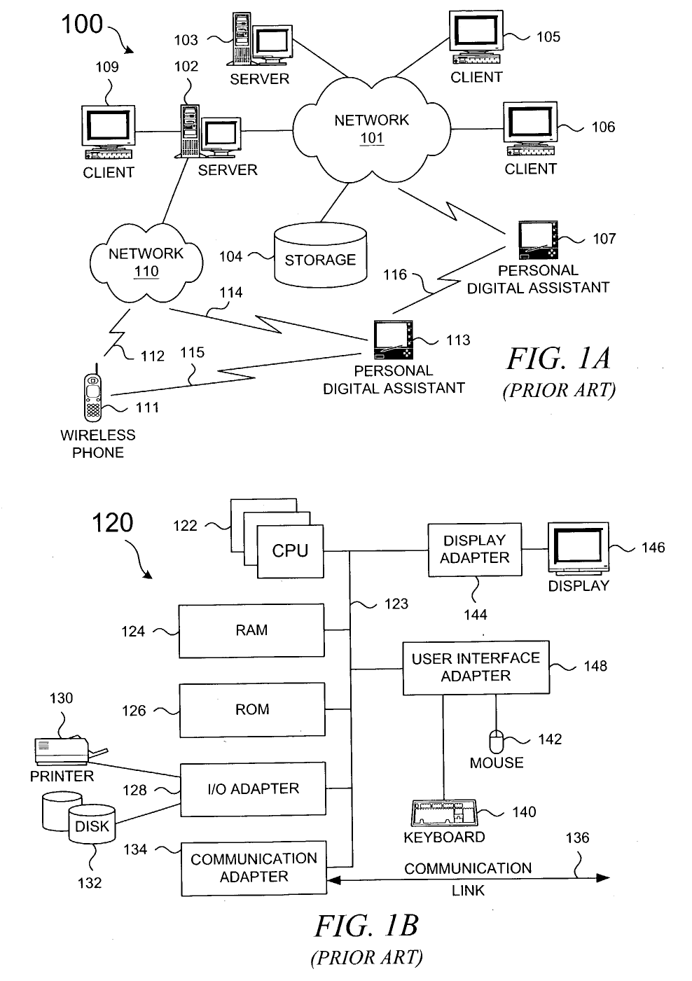

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as File Transfer Protocol (FTP), Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to a firewall system that can be dynamically controlled by host systems and applications in order to reduce the computational burden on a firewall and increase its throughput, as described in more detail below with respect to the remaining figures.

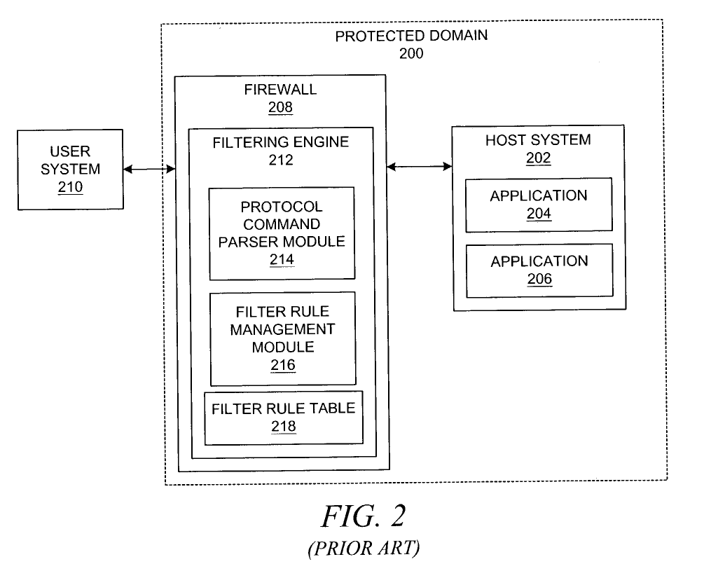

With reference now to FIG. 2, a distributed data processing system with a typical firewall implementation is shown. Domain 200 supports host system 202, which itself supports applications 204 and 206. Domain 200 is protected by firewall 208 from illegitimate activities, e.g., a malicious user at user system 210 that might launch various probes or attacks at host system 202. Firewall 208 filters incoming and outgoing commands and data for various communication protocols through its filtering engine 212. Protocol command parser module 214 parses protocol commands. If valid commands are recognized, then protocol command parser module 214 triggers filter rule management module 216 to create new filter rules or to delete currently active filter rules that are stored within filter rule table 218.

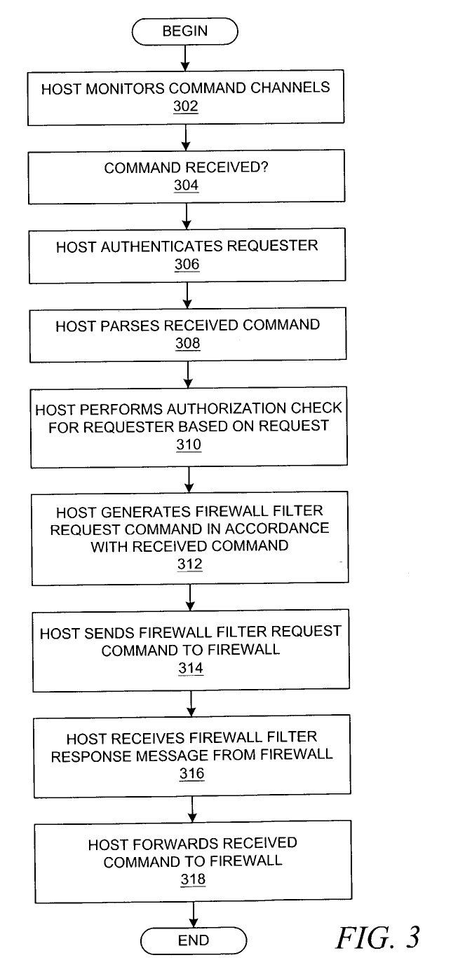

With reference now to FIG. 3, a flowchart depicts a process in which the parsing of protocol commands is performed by a host system in accordance with the present invention. Rather than parsing protocol commands within a typical firewall, the present invention shifts the computational burden of processing protocol commands to a host system or host application. As a result, the host system or host application interoperates with the firewall to ensure that the firewall allows data transfers in accordance with the requirements of the processed protocol commands. The process that is shown in FIG. 3 refers to a host, which may be a host system that supports multiple applications that generate protocol commands; alternatively, the host may be a host application that supports the communication requirements of requesters, which may be software objects, modules, or other applications.

The process begins with the host monitoring one or more communication protocol command channels (step 302). The host determines if a command has been received (step 304), and if not, it cycles until a command is detected. If the host has received a command, then the host authenticates the requester if necessary (step 306); the host may have cached authentication information for the requester such that the requester is not authenticated for each request during a particular session. If the authentication fails, then the requested command would be failed and returned to the requester in some manner.

Assuming the authentication operation is successful, the host then parses the received command (step 308). After determining the type of command and its associated parameters, the host performs an authorization check based on the authenticated identity of the requester, the command type, and/or the command parameters if necessary (step 310); the host may have cached authorization information for the requester such that the requester is not authorized for each identical request during a particular session. If the authorization fails, then the requested command would be failed and returned to the requester in some manner.

Assuming the authorization is successful, the host generates a firewall filter request command in accordance with the received command (step 312). In other words, the generated firewall filter request command contains information about the type of protocol command and, most likely, its parameters. The firewall filter request command is then sent from the host to the firewall (step 314). The firewall filter request command instructs the firewall to create a filter rule for the originally received command; thereafter, subsequent data transfers that are associated with the command are allowed to pass through the firewall.

The host eventually receives a firewall filter response message that corresponds to the firewall filter request command (step 316). Assuming that the firewall filter was successfully created, the host then forwards the originally received command to the firewall so that the communication session can be initiated or continued (step 318), and the process is complete.

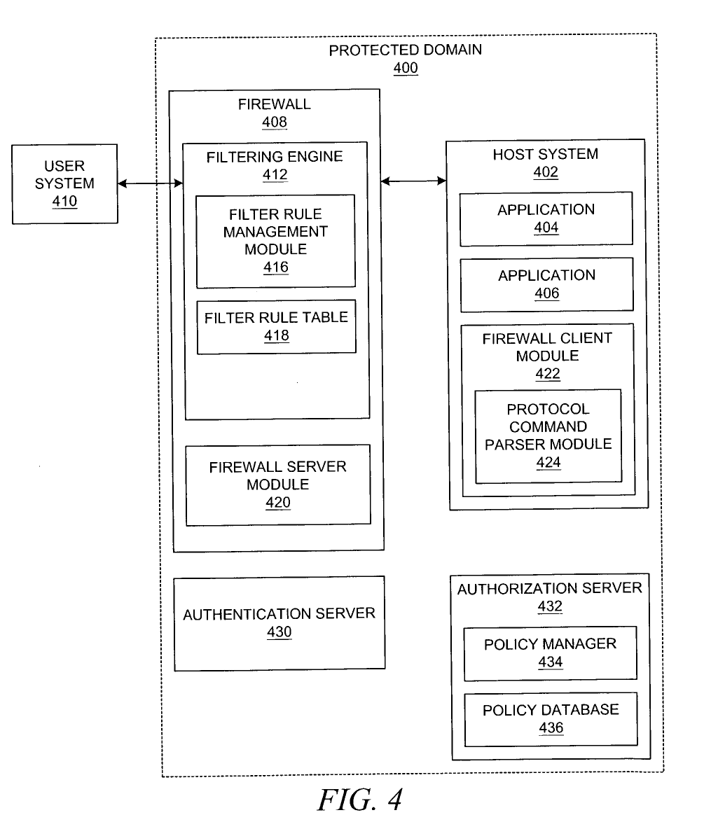

With reference now to FIG. 4, a distributed data processing system is shown with a firewall system implemented in accordance with the present invention. FIG. 4 depicts some components in a manner similar to that shown in FIG. 2. Domain 400 supports host system 402, which itself supports applications 404 and 406. Domain 400 is protected by firewall 408; user system 410 may request resources from host system 402. Firewall 408 filters incoming and outgoing commands and data for various communication protocols through its filtering engine 412. Filter rule management module 416 creates new filter rules or deletes currently active filter rules that are stored within filter rule table 418.

In contrast to a typical firewall implementation as shown in FIG. 2, FIG. 4 depicts a firewall implementation in accordance with the present invention in which a protocol command parser module is not contained within the firewall. Instead, firewall 408 supports firewall server module 420, which responds to requests from firewall client module 422. Firewall server module 420 interacts with filtering engine 412 to perform operations on filter rules that are requested by firewall client modules. Firewall client module 422 supports protocol command parser module 424, which is similar to protocol command parser module 214 in FIG. 2. Protocol command parser module 424 monitors command channels within host system 402, and if an outgoing command is detected, then protocol command parser module 424 triggers firewall client module 422 to request the creation of a filter rule via firewall server module 420 at firewall 408. Assuming that the filter rule is successfully configured, then data transfers corresponding to the requirements of the outgoing command will be allowed by firewall 408. In this manner, the computational burden of detecting and parsing protocol commands is distributed amongst a set of firewall client modules, one of which is configured at each host system that communicates through the firewall.

In the embodiment of the present invention that is depicted within FIG. 4, a firewall client module is supported on each host system, which may support multiple applications that need to transfer data through the firewall. In an alternative embodiment, a firewall client module is supported by each application that transfers data through the firewall. In other words, the application itself, e.g., such as an FTP application daemon, sends the command to the firewall in order to enable a data connection before sending an FTP request (in the case of an active FTP implementation). Although each application daemon would need to be rewritten to accommodate this functionality, it would avoid the need for a protocol command parser module that can parse protocol commands for many different protocols.

The present invention may optionally support authentication and authorization operations at the host system and the firewall. Authentication server 430 within domain 400 provides authentication services to applications or other entities that operate within domain 400. Similarly, authorization server 432 within domain 400 provides authorization services to applications or other entities that operate within domain 400. The manner in which authentication and authorization operations occur within a given domain may vary with the implementation of the present invention, and many different standard or proprietary authentication and authorization protocols may be employed. However, it should be noted that the present invention supports many different authentication and authorization scenarios. Firewall client module 422 firewall server module 420 authenticates firewall client module 422, and thereafter, the firewall server module 420 processes all requests from firewall client module 422; in other words, in an example implementation, no authorization operations are required between the firewall server module and the firewall client module. In addition, commands between the firewall server module and the firewall client module are encrypted and digitally signed to enhance security within the system.

Firewall operations, though, are performed on behalf of an application, and every application should not have authorization to transfer data through the firewall, or more specifically, every application should not have authorization to transfer data through the firewall for all communication protocols. Hence, after firewall client module 422 has parsed a particular instance of a protocol command from a particular application, firewall client module 422 determines whether the application that has sent the protocol command is authorized to request that particular type of protocol command. In this manner, authorization operations are pushed away from the firewall toward the requesting application. Given a computational environment in which the requesting application executes directly on host system 402 along with firewall client module 422, firewall client module 422 can inherently trust the requesting application due to the nature of their interaction, such as an application programming interface that cannot be invoked remotely.

The advantages of the present invention should be apparent in view of the detailed description that is provided above. Prior art solutions require a firewall to parse commands that are detected within monitored command channels through the firewall, after which filter rules are activated to allow data transfers through those channels or ports.

Instead of having a firewall monitor all of the command channels of different hosts within the protected network, each host monitors its own command channels, and each host instructs the firewall as to which ports to open. Interaction between a firewall and a host that requests filter rule operations at the firewall may be secured through encryption, authentication, and authorization operations. The firewall of the present invention is much more lightweight and much faster than typical firewall implementations because the firewall neither has to monitor command channels nor parse differently formatted commands from different applications. Moreover, the present invention facilitates a host and application-based security policy because not every host and application may be given the permission to open data channels dynamically on the firewall.

The advantages of the present invention can be illustrated by means of an example, in particular, through an example using the FTP protocol.

FTP uses two different modes of operation, normal and passive. In normal FTP, the client sends a request for FTP along with the random port number on which it wants the server to send the data to be transferred. The FTP server then opens a data connection to the client on this port, usually between 1024-5000. This type of FTP is also called active FTP because the server actively opens a connection back to the client. In passive FTP, the server sends the port number on which it will send to the client the data to be transferred. The client then opens a data connection on the server on the indicated port. Since the server does not actively open a data connection on the client, this type of connection is called passive FTP.

Both forms of FTP need filter rules to be dynamically created at the firewall: if the client is behind a firewall in the case of normal FTP; and if the server is behind a firewall in the case of passive FTP.

Currently, dynamic firewall implementations create filtering rules in order to facilitate such data transfers by monitoring the requests send and received. In normal FTP, a dynamic firewall protecting the client would parse the client request for the port number on which it is ready to receive data. This firewall would then create a rule which would allow data transfer on that port. In passive FTP, the firewall protecting the server would parse the server response for the port on which the client should connect in order to get the data. However, in all of these firewall implementations, the firewall has to monitor the commands being sent and parse each command in order to find out the port information contained in them. This reduces the speed of the firewall. Moreover, different applications send out the port information in different formats and, therefore, need to be handled differently at the firewall. Applications fail if the firewalls cannot parse their request commands.

Instead of having the firewall monitor all the command channels of different hosts within the protected network, each host monitors it's own command channels. When a client behind a firewall makes an FTP (normal FTP) request, this client sends a command to the firewall telling it to allow a data connection from the remote server to a particular port on the client. This interaction between the firewall and the client is preferably encrypted and authenticated. Similarly, for passive FTP, when a server behind the firewall responds to an FTP request, it sends a command to the firewall telling it to allow the data transfer. This makes the firewall lightweight and much faster because it neither has to monitor command channels nor parse commands from different applications and handle each differently. Moreover, this facilitates a host and application-based security policy because not every host an application may be given the permission to open data channels dynamically on the firewall. It should also be noted that typical firewall processing may still occur if the present invention is implemented on a firewall.

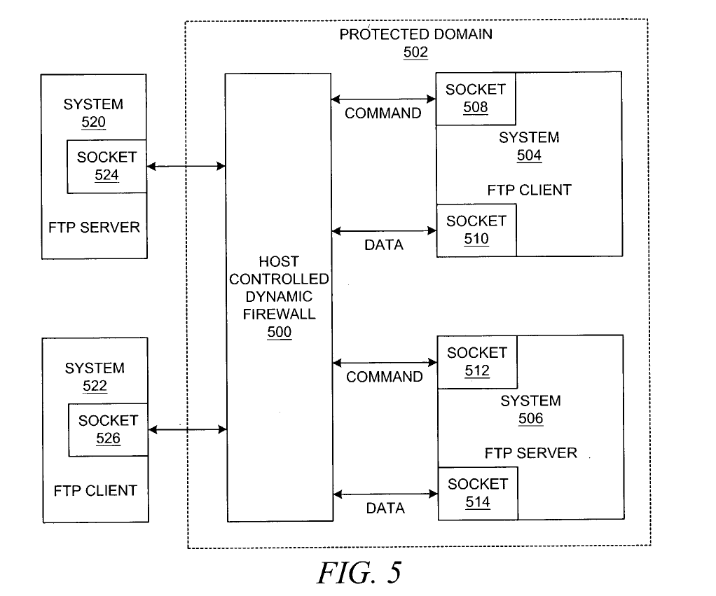

With reference now to FIG. 5, a block diagram depicts a host controlled dynamic firewall system for an example using FTP. Host controlled dynamic firewall 500 resides within protected domain 502 along with system 504 and system 506. In this example, system 504 acts as an FTP client and supports sockets 508 and 510; system 506 acts as an FTP server and supports sockets 512 and 514. Systems 520 and 522 reside outside of protected domain 502. System 520 acts as an FTP server and supports socket 524. System 522 acts as an FTP client and supports socket 526.

In normal FTP, system 504 sends a command to host controlled dynamic firewall 500 before system 504 sends out an FTP request command to system 520. This command instructs firewall 500 to enable the data connection; in other words, the command requests that the firewall insert a rule into its filter rule table to allow the connection from socket 524 on system 520 to socket 510 on system 504 through the firewall.

In passive FTP, system 506 sends a command to firewall 500 before sending out the port information to system 522. This command instructs firewall 500 to enable the data connection between socket 526 and socket 514.

After systems 504 and 506 complete their respective data transfers, they instruct the firewall to remove the previously generated rules from its filter rule table, i.e. the rules that were used for their data transfers. This ensures that connections are allowed only for the duration of a data transfer.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for operating a firewall, the method comprising:
monitoring one or more communication channels at a host within a domain protected by a firewall;
detecting a communication protocol command in a communication channel at the host;
generating a firewall command at the host, wherein information within the firewall command is based on information within the communication protocol command; and
sending the firewall command from the host to the firewall to create a filtering condition at the firewall such that subsequent data transfers in accordance with the communication protocol command are allowed by the firewall.

2. The method of claim 1 further comprising:
parsing the communication protocol command at the host to determine a protocol command type.

3. The method of claim 2 further comprising:
extracting protocol command parameters from the communication protocol command;
determining a port number from the extracted protocol command parameters; and
placing the port number in the firewall command.

4. The method of claim 1 further comprising:
performing an authentication check at the host based an identity of a requesting entity at the host.

5. The method of claim 1 further comprising:
performing an authorization check at the host based on information within the communication protocol command and an identity of a requesting entity at the host.

6. The method of claim 1 further comprising:
wherein the host is a data processing system.

7. The method of claim 1 further comprising:
wherein the host is an application.

8. An apparatus for operating a firewall, the apparatus comprising:
means for monitoring one or more communication channels at a host within a domain protected by a firewall;
means for detecting a communication protocol command in a communication channel at the host;
means for generating a firewall command at the host, wherein information within the firewall command is based on information within the communication protocol command; and
means for sending the firewall command from the host to the firewall to create a filtering condition at the firewall such that subsequent data transfers in accordance with the communication protocol command are allowed by the firewall.

9. The apparatus of claim 8 further comprising:
means for parsing the communication protocol command at the host to determine a protocol command type.

10. The apparatus of claim 9 further comprising:
means for extracting protocol command parameters from the communication protocol command;
means for determining a port number from the extracted protocol command parameters; and
means for placing the port number in the firewall command.

11. The apparatus of claim 8 further comprising:
means for performing an authentication check at the host based an identity of a requesting entity at the host.

12. The apparatus of claim 8 further comprising:
means for performing an authorization check at the host based on information within the communication protocol command and an identity of a requesting entity at the host.

13. The apparatus of claim 8 further comprising:
wherein the host is a data processing system.

14. The apparatus of claim 8 further comprising:
wherein the host is an application.

15. A computer program product in a computer readable medium for use in operating a firewall, the computer program product comprising:
means for monitoring one or more communication channels at a host within a domain protected by a firewall;
means for detecting a communication protocol command in a communication channel at the host;
means for generating a firewall command at the host, wherein information within the firewall command is based on information within the communication protocol command; and
means for sending the firewall command from the host to the firewall to create a filtering condition at the firewall such that subsequent data transfers in accordance with the communication protocol command are allowed by the firewall.

16. The computer program product of claim 15 further comprising:
means for parsing the communication protocol command at the host to determine a protocol command type.

17. The computer program product of claim 16 further comprising:
means for extracting protocol command parameters from the communication protocol command;
means for determining a port number from the extracted protocol command parameters; and
means for placing the port number in the firewall command.

18. The computer program product of claim 15 further comprising:
means for performing an authentication check at the host based an identity of a requesting entity at the host.

19. The computer program product of claim 15 further comprising:
means for performing an authorization check at the host based on information within the communication protocol command and an identity of a requesting entity at the host.

20. The computer program product of claim 15 further comprising:
wherein the host is a data processing system.

21. The computer program product of claim 15 further comprising:
wherein the host is an application.
